(19) United States
(12) Patent Application Publication
(10) Pub. No.: US 2014/0223051 A1
(43) Pub. Date: Aug. 7, 2014

(54) INFORMATION COLLECTION SYSTEM

(71) Applicant: ANDES TECHNOLOGY CORPORATION, Hsin-Chu City (TW)

(72) Inventors: Yi-Jong Yeh, Taipei City (TW); Chi-Chang Lai, Hsinchu County (TW)

(73) Assignee: ANDES TECHNOLOGY CORPORATION, Hsin-Chu City (TW)

(21) Appl. No.: 13/762,337

(22) Filed: Feb. 7, 2013

(51) Int. Cl. G06F 13/40

(52) U.S. Cl. CPC G06F 13/40
USPC 710/110

(57) ABSTRACT

An information collection system is provided. The information collection system includes an information collection unit, an information initiation unit, and an information relay unit. The information collection unit includes at least one slave port, and the information collection unit responds a transaction through the slave port. The information initiation unit includes at least one master port, and the information initiation unit initiates the transaction through the master port. The information relay unit includes at least one master port and at least one slave port, and the information relay unit relays the transaction through the master port and the slave port wherein the transaction includes a write transaction. Wherein, during an identification phase, the master port of the information initiation unit delivers a header, and the slave port of the information collection unit accepts the transaction according to the header.

### BACKGROUND OF THE INVENTION

1. Field of the Invention

The invention generally relates to an information collection system, in particular, to an information collection system with multiple forms of topologies.

2. Description of Related Art

A common information collection system of a prior art is usually implemented with a bus and a plurality of circuits. In the information collection system of a prior art, usually master ports of circuits and slave ports of circuits are all connected to the bus. For example, the inter-integrated circuit (IIC) protocol is usually used for the information among different integrated circuits. In a real operation, a master port of an integrated circuit initiates a transaction and the corresponding slave port of an integrated circuit responds the transaction after responding an acknowledge from the slave port which represents that the transaction is acceptable. For instance, when initiating a write transaction, the master port sends the address of the corresponding slave port through the bus first. After waiting for responding by asserting acknowledge from the slave port, the master port delivers data through the bus. Likewise, when initiating a read transaction, a master port allows a slave port to send data after waiting for responding by asserting acknowledge from the slave port through the bus too.

On the other hand, since all the master ports and slave ports are all connected to the bus directly, one transaction is only transferred at a time. Once a transaction is initiated or responded between a master port and a slave port, the bus is occupied and other master ports and slave ports of the information collection system of a prior art will not be able to deliver other transactions until the bus is released. As described above, because usually a protocol like IIC requires an extra time for responding acknowledge and a transaction is only delivered at a time, the information collection system of a prior art is not efficient.

### SUMMARY OF THE INVENTION

Accordingly, the present invention is directed to an information collection system and further to an information collection system with a link between each of the master ports and each of the corresponding slave ports in the information collection system to be more efficient.

The present invention is directed to an information collection system, and the information collection system includes an information collection unit, an information initiation unit, and an information relay unit. The information collection unit includes at least one slave port, and the information collection unit responds a transaction through the slave port. The information initiation unit includes at least one master port, and the information initiation unit initiates the transaction through the master port. The information relay unit includes at least one master port and at least one slave port, and the information relay unit relays the transaction through the master port and the slave port. A transaction is comprised of an identification phase, a data phase, an end-of-frame phase and a idle phase. Wherein, during an identification phase, the master port of the information initiation unit delivers a header, and the slave port of the information collection unit accepts the transaction according to the header. During a data phase, the master port of the information initiation unit delivers data to the slave port of the information collection unit. Wherein, the transaction is initiated, relayed or responded through a link. The link includes a frame signal, a validation signal, a data bus, and response signals. The frame signal is asserted by the master port for declaring to occupy the link. Information of the transaction is delivered through the data bus. The validation signal is asserted by the master port along with the valid data. And, the slave port informs the master port that the transaction is accepted through the response signals with an accepted state.

Based on the description above, an information collection system is provided and the information collection system includes at least one information initiation unit, and at least one information collection unit. An information collection system can further include one or more information relay units. A transaction is transferred through a link between a master port and a slave port. Wherein, when the information initiation unit initiates the transaction through the link, the information relay unit relays the transaction to the slave port of the information collection unit. The information collection unit responds the transaction according to the header, and the slave port of the information collection unit responds the transaction to the master port of the information initiation unit by asserting response signals of the link with an accepted state. Thus, the transaction is transferred efficiently since the header and data may be transferred in associated phases regardless the state of the response, though usually the initiator would stop transferring when ABORT or YIELD state observed, separate response states of ABORT and YIELD can be used for more efficient re-transmission decisions, and distributed arbitration may be done in each relay unit according to the transaction priority.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic view of an information collection system according to an embodiment of the invention.

FIG. 2 shows a delineation of a transaction 200 according to an embodiment of the invention.

FIG. 3 shows a schematic view of a header 210 according to an embodiment of the invention.

FIG. 4A shows a waveform of a speculative write transaction of a link of an information collection system according to an embodiment of the invention.

FIG. 4B shows a waveform of a write transaction of a link of an information collection system according to another embodiment of the invention.

FIG. 5 shows a waveform of a read transaction of a link of an information collection system according to an embodiment of the invention.

FIG. 6 shows a waveform of a special transaction of a link of an information collection system according to an embodiment of the invention.

FIG. 7 shows a schematic view of an information collection system according to an embodiment of the invention.

FIG. 8 shows a schematic view of an information collection system according to an embodiment of the invention.

FIG. 9 shows a schematic view of an information collection system according to an embodiment of the invention.

FIG. 10 shows a schematic view of an information collection system according to an embodiment of the invention.

FIG. 11 shows a schematic view of an information collection system according to an embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

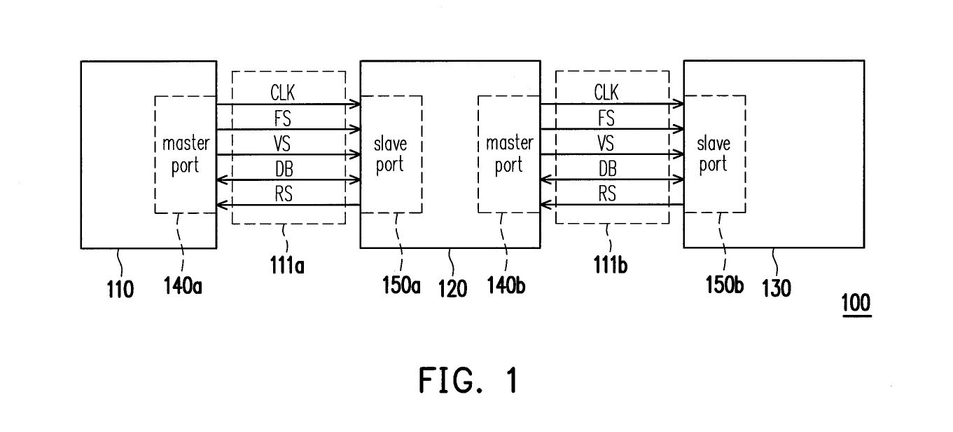

FIG. 1 shows a schematic view of an information collection system 100 according to an embodiment of the invention. Please refer to FIG. 1. The information collection system 100 includes an information collection unit 130, an information relay unit 120, and an information initiation unit 110. Generally speaking, a master port is used for initiating a transaction, while a slave port is used for responding the transaction. The information initiation unit 110 includes at least a master port 140a for initiating a transaction. The information collection unit 130 includes at least a slave port 150b for responding the transaction. Additionally, the information relay unit 120 includes at least one slave port 150a and at least one master port 140b. The slave port 150a of the information relay unit 120 receives the transaction from the master port 140a of the information initiation unit 110. Then, for relaying the transaction, the master port 140b of the information relay unit 120 transfers the transaction to the slave port 150b of the information collection unit 130. In specifics, when relaying a transaction from the slave port 150a of the information relay unit 120 to the master port 140b of the information relay unit 120, the information relay unit 120 drives the output signals of the master port 140b with an one-to-one correspondence to the same signals observed at the slave port 150a, with a predetermined time delay. On the other hand, the information relay unit 120 drives the output signals at the slave port 150a (the response signals) for relaying the transaction according to the corresponding signals at the master port 140a in the similar manner.

According to an embodiment of the invention, besides relaying a transaction, the information relay unit 120 includes at least a master port 140b, so the information relay unit 120 may initiate a transaction. Likewise, because the information relay unit 120 includes at least a slave port 150a, the information relay unit 120 may be used for responding a transaction.

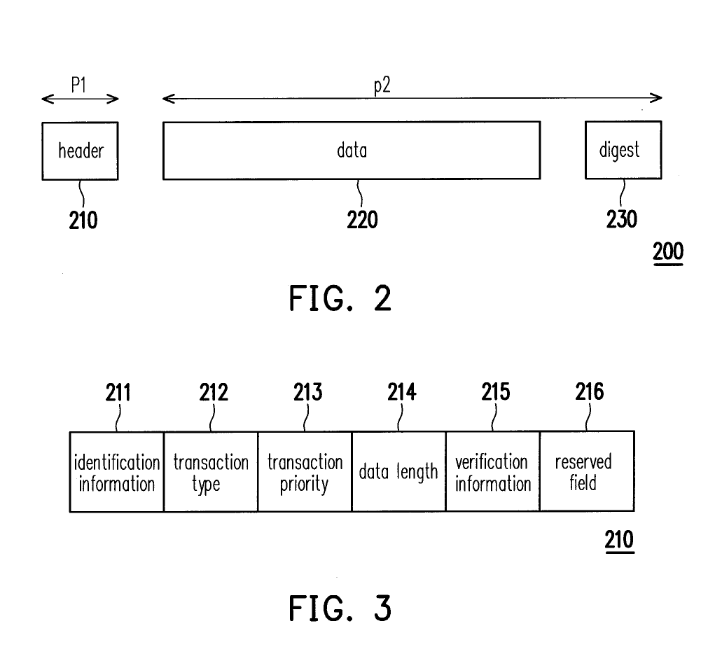

FIG. 2 shows a delineation of a transaction 200 according to an embodiment of the invention. Please refer to FIG. 2. A transaction may be illustrated as the following description: during different phases, different types of information are delivered respectively. According to an embodiment of the invention, a transaction 200 includes types of information as the following elements: a header 210, data 220, and a digest 230. During an identification phase P1, the header 210 is delivered. And, during a data phase P2, the data 220 and the digest 230 are delivered.

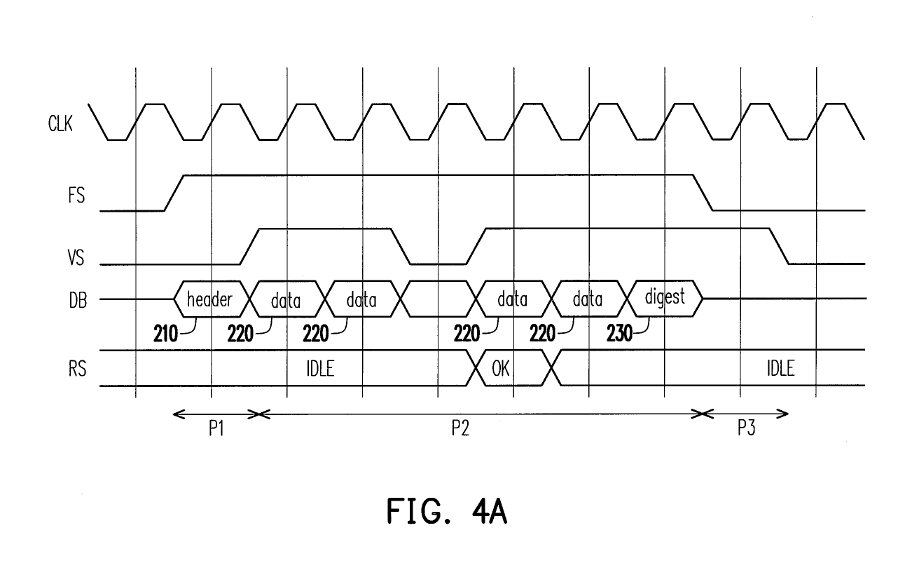

FIG. 3 shows a schematic view of a header 210 according to an embodiment of the invention. Please refer from FIG. 1 to FIG. 3. The header 210 may include e.g. identification information 211, a transaction type 212, a transaction priority 213, a data length 214, and verification information 215. The identification information 211 is used to identify the source and the destination of the transaction 200. For example, the identification information 211 includes a source identification code which represents the master port 140a and includes a destination identification code which represents the slave port 150b. Then the slave port 150a decides to relay the transaction 200 or the slave port 150b decides to respond the transaction 200 according to the identification information 211. Besides, the transaction type 212 includes e.g. a read transaction or a write transaction and the slave port 150b responds the transaction 200 according to the transaction type. For example, the slave port 150b transmits the data 220 when receiving a read transaction, or receives the data 220 when receiving a write transaction. According to an embodiment of the invention, the transaction priority 213 may include e.g. a credit which represents the priority of the transaction 200. When the transaction 200 is in a race condition, the information relay unit 120 judges if yielding the transaction 200 or not. For example, when the information relay unit 120 is relaying a transaction 200 with the value 1 of credit, the information relay unit 120 is receiving another request of a transaction 200 with the value 2 of credit at the same time. At this time, the information relay unit 120 will yield the transaction 200 with the value 1 of credit, that is, the information relay unit 120 will interrupt the transaction 200 with the value 1 of credit, and will relay the transaction 200 with the value 2 of credit instead. Moreover, the credit may be a combination of a static part and a dynamic part. The static part may be determined according to an initialization process of the information collection system 100, and the dynamic part may be changed in a transaction retransmission dynamically.

According to an embodiment of the invention, the data length 214 may include e.g. the number of the records of the data 220 of the transaction 200 wherein the width of each record of the data 220 is implementation dependent. For example, the width of each record of the data 220 is one 32-bit word. In addition, the verification information 215 is used to verify the accuracy of the header 210. For example, the verification information 215 includes a CRC (Cyclic Redundancy Check) code which is correspondent with the header 210. After the slave port 150b receives the header 210, the validation of the header 210 is verified by checking if the CRC code is correspondent with the header 210. If the verification is failed, the transaction 200 might be repeated later. The header 210 of the embodiment may further include other information in an e.g. reserved field 260 which could be defined by users, and the information of the header 210 is not limited thereto.

Likewise, the digest 230 is also used to verify the accuracy of the data 220. For example, the digest 230 includes a CRC code which is correspondent to the data 220 and the master port 140a or the slave port 150b which receives the data 220 can check if the data 220 are correspondent with the CRC code. If so, the data 220 is accurate. Otherwise, the transaction 200 may be aborted and repeated the unfinished transaction 200 later. According to an embodiment of the invention, the digest 230 could be excluded from the transaction 200. That is, according to the characteristic of the transaction 200, the data 220 is not necessary to be verified. Usually, the transaction 200 mentioned above which excludes the digest 230 requires high bandwidth but could tolerate data error, e.g. an application in video transfers.

According to an embodiment of the invention, the transaction 200 is initiated or responded through a link 111a which is coupled to the master port 140b of the information relay unit 120 and a link 111b which is coupled to the slave port 150a of the information relay unit 120. The links 111a and 111b include a clock signal CLK, a frame signal FS, and a validation signal VS which are asserted by the master port 140a, and response signals RS asserted by the slave port 150b, and a data bus DB. The data bus DB is bi-directional, that is, information such as the data 220 and the digest 230 could be transferred from the master port 140a to the slave port 150b or from the slave port 150b to the master port 140a.

As described above, when the information relay unit 120 relays the transaction 200 initiated by the information initiation unit 110 from the link 111a to the link 111b, the signals (CLK, FB, VS) of the link 111a and the information delivered through the data bus DB of the link 111a initiated by the information initiation unit 110 are bypassed to the link 111b. Similarly, when the information relay unit relays the transaction 200 responded by the information collection unit 130 from the link 110b to the link 110a, the response signals RS of the link 111b and the information delivered through the data bus DB of the link 111b responded by the information collection unit 130 are bypassed from the link 111b to the link 111a. By bypassing the signals (CLK, FS, VS) and the information delivered through the data bus DB from the link 111a to the link 111b, or by bypassing the response signals RS and the information delivered through the data bus DB from the link 111b to the link 111a, the information relay unit 120 relays the transaction 200.

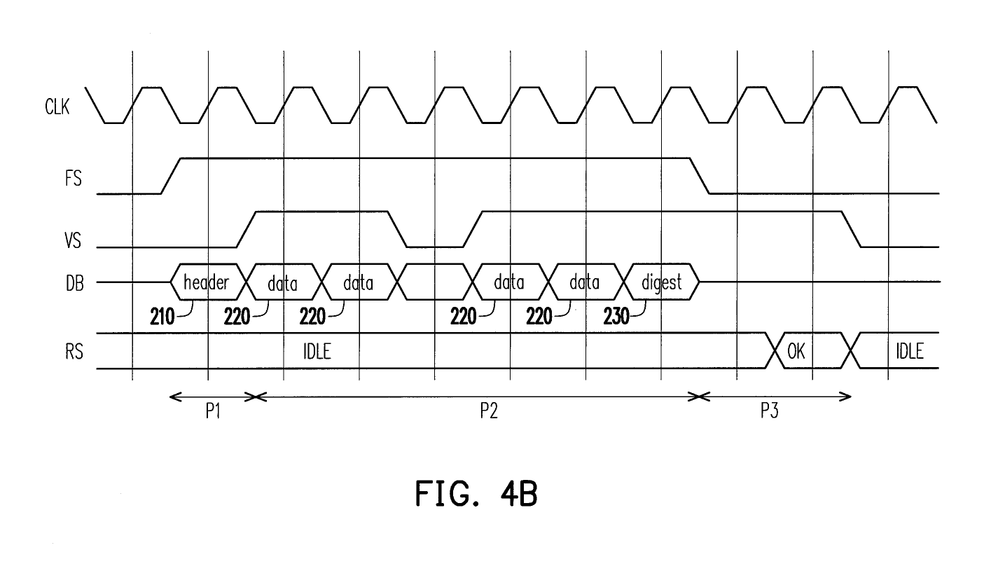

FIG. 4A shows a waveform of a speculative write transaction through a link of the information collection system 100 according to an embodiment of the invention. Please refer from FIG. 1 to FIG. 4A. According to the embodiment, the transaction 200 may be a write transaction. During an identification phase P1, the master port 140a of the information initiation unit 110 asserts the frame signal FS to declare that the link 111a is occupied, and delivers the header 210 through the data bus DB. During a data phase P2, the master port 140a of the information initiation unit 110 delivers the data 220 to the slave port 150b and asserts the validation signal VS to indicate the valid data 220. Besides, if the slave port 150b assures that the transaction 200 can be accepted according to the data length 214 of the header 210, the slave port 150b replies the response signals RS with an accepted state OK during the data phase P2. Then, the transaction 200 further includes an end of frame phase P3. During the end of frame phase P3, the master port 140a de-asserts the frame signal FS and stops delivering information through the data bus DB. The response signals RS enter an idle state IDLE after the accepted state OK wherein the idle state IDLE is usually responded as a default state of the response signals RS. Besides, the clock signal CLK is used to synchronize the information delivered through the data bus DB such as the header 210, the data 220, and the digest 230, and etc.

According to an embodiment of the invention, the response signals RS may include an aborting state ABORT. If the slave port 150b of the information collection unit 130 is unable to accept the data 220 of the transaction 200, the slave port 150b asserts the response signals RS with the aborting state ABORT to inform the information initiation unit 110 that the transaction 200 is not accepted. For example, if receiving a write transaction, the slave port 150b observes that there is not enough space for receiving the data 220 by the slave port 150b according to the data length 214 of the header 210, or if the slave port 150b finds out that there is not enough space for the data 220 while receiving the data 220 during the data phase P2, the transaction 200 will be aborted. After aborting the unfinished transaction 200, the master port 140a might initiate the unfinished transaction 200 again later. It should be noted that, the frequency and latency of the response signals RS having the aborting state ABORT observed at the master port 140a may be used to calculate the static part of the credit for the priority field of the transactions to be initiated in the information initiation unit 110, during any further initialization of the information collection system 100.

According to an embodiment of the invention, the response signals RS may also include a yielding state YIELD. If the information relay unit 120 is relaying the transaction 200 e.g. relaying the transaction 200 initiated by the master port 140a to the slave port 150b and another transaction 200 e.g. the transaction 200 from the information relay unit 120 requires the information relay unit 120 for transferring to the slave port 150b at the same time, the information relay unit 120 will compare the priorities between the two transactions 200. If the priority of the transaction 200 initiated by the information relay unit 120 for the master port 140b is higher, the information relay unit 120 will interrupt the transaction 200 initiated by the master port 140a and replies the response signals RS with the yielding state YIELD for informing the master port 140a that the transaction 200 of the information initiation unit 110 is not finished. On the other hand, the master port 140a might repeat the yielded transaction 200 again later, and the master port 140a might raise the value of credit of the transaction priority 213 of the header 210 for preventing the yielded transaction 200 being yielded easily in the later transaction. For fair compensation, it should be appreciated that the value to be added to the dynamic part of the credit of the transaction priority may depend on the latency of the response signals RS with the yielding state YIELD observed at the master port 140a.

FIG. 4B shows a waveform of a write transaction through a link of the information collection system 100 according to another embodiment of the invention. Please refer to FIG. 1, FIG. 2, and FIG. 4B. This embodiment is similar to the embodiment of FIG. 4A. In the dissimilar part, the slave port 150b of the information collection unit 130 replies the response signals RS during the end of frame phase P3. It should be noted that, because the link 111a and 111b allow the transaction 200 to reply the response signals RS during the data phase P2 or during the end of phase P3, the information collection system 100 of the invention is more flexible, and the time for waiting response is saved through the independent response signals RS. Then, the transaction 200 is more efficient through the behaviour of the response signals RS.

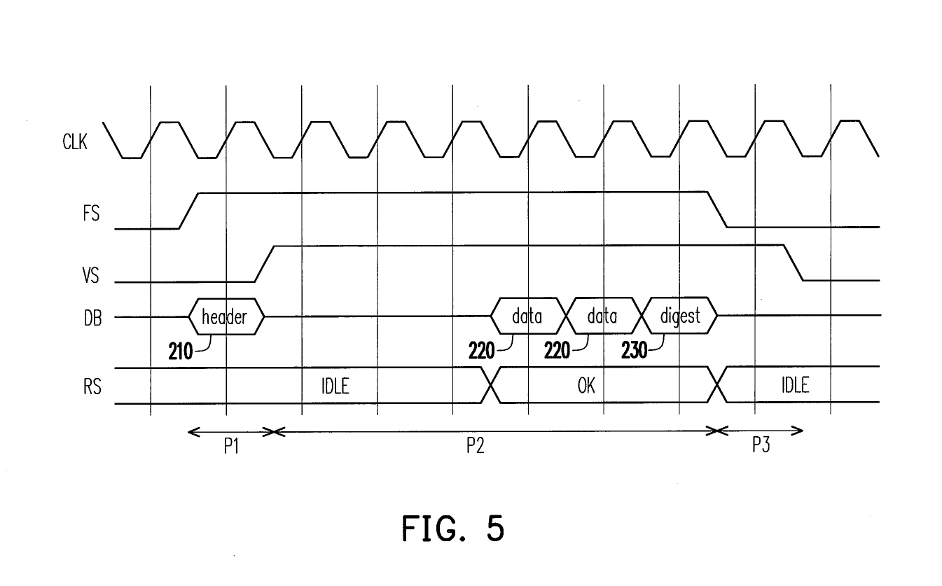

FIG. 5 shows a waveform of a read transaction through a link of the information collection system 100 according to an embodiment of the invention. Please refer to FIG. 1, FIG. 2, and FIG. 5. According to the embodiment, the transaction 200 may be a read transaction. The clock signal CLK, the frame signal FS, and the validation signal VS are similar to the embodiment of FIG. 4A in most parts. In the dissimilar part, during the data phase P2, the slave port 150b of the information collection unit 130 transfers the data 220 and the digest 230 to the master port 140a of the information initiation unit 110. In addition, the valid data 220 is indicated by the response signals RS with the accepted state OK.

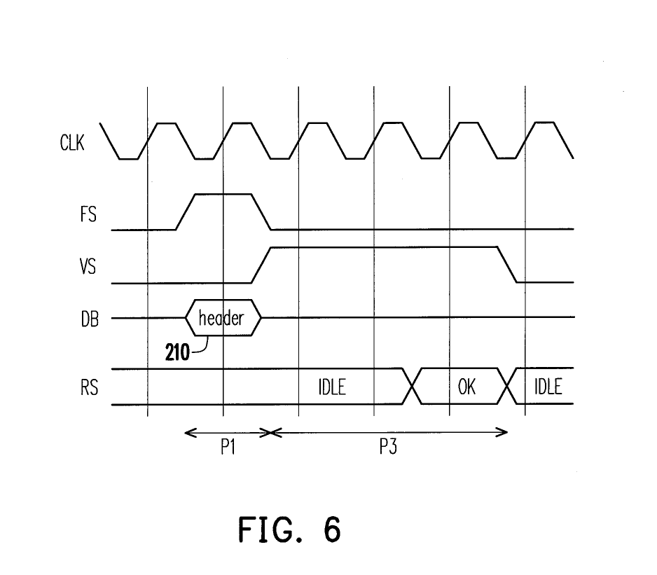

FIG. 6 shows a waveform of a special transaction through a link of the information collection system 100 according to an embodiment of the invention. Please refer to FIG. 1, FIG. 2, and FIG. 6. When receiving a special transaction, the master port 140a of the information initiation unit 110 only delivers the header 210 to the slave port 150b of the information collection init 130. During the identification phase P1, the master port 140a of the information initiation unit 110 asserts the frame signal FS and delivers the header 210 to the slave port 150b of the information collection unit 130. After the identification phase P1, the end of frame phase P3 is entered. And, during the end of frame phase P3, the validation signal VS is asserted and the frame signal FS is de-asserted at first time. After the slave port 150b replies the response signals RS with the accepted state OK, the validation signal VS is de-asserted and the special transaction of the transaction 200 of the links 111a and 111b is finished.

According to an embodiment of the invention, the information collection system of the invention may be implemented through one or a plurality of the information initiation units, the information relay units, and the information collection units. Wherein, the information initiation units, the information relay units, and the information collection units may include one or a plurality of the master ports and slave ports. Then, various topologies are formed with the connections through the links between each of the master ports and each of the slave ports in the information collection system.

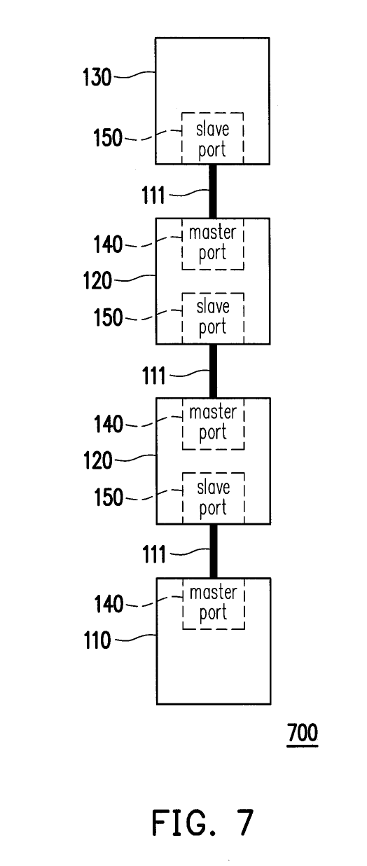

FIG. 7 shows a schematic view of an information collection system 700 according to an embodiment of the invention. Please refer to FIG. 7. The information collection system 700 includes one information initiation unit 110, one information collection unit 130, and one or a plurality of information relay units 120. To be similar to the information collection system 100 in FIG. 1, the information initiation unit 110 is coupled to the information collection unit 130 through the link 111, and the information relay units 120 are serially connected on the path where the information initiation unit 110 is coupled to the information collection unit 130 through the link 111. Then, a chain topology is formed.

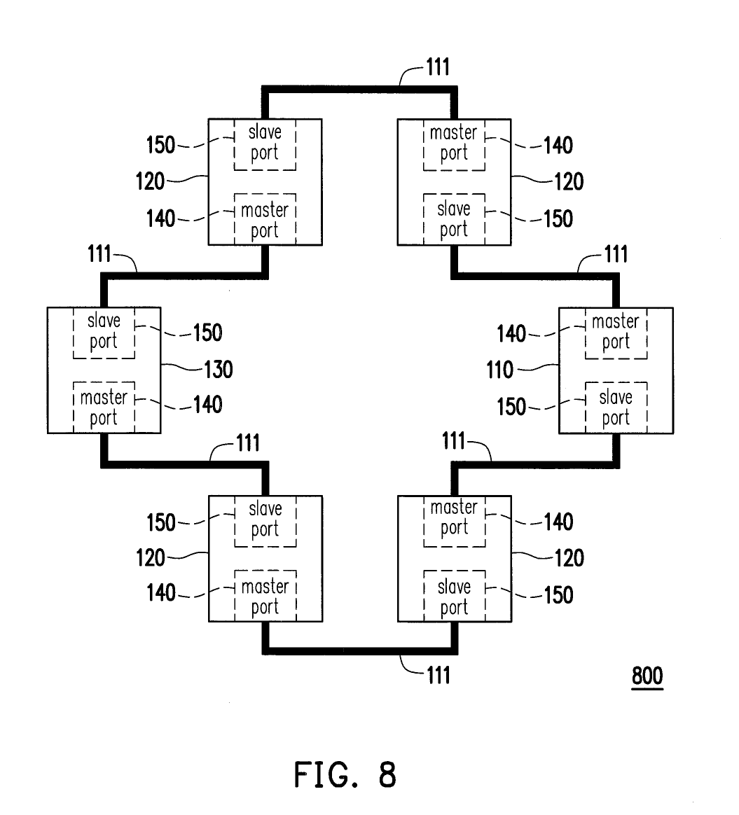

FIG. 8 shows a schematic view of an information collection system 800 according to an embodiment of the invention. Please refer to FIG. 8. The information collection system 800 includes at least one information initiation unit 110, at least one information collection unit 130, and one or a plurality of information relay units 120. Compared with the embodiment of FIG. 1, the information initiation unit 110 further includes at least one slave port 150 for responding a transaction. The information collection unit 130 further includes at least one master port 140 for initiating the transaction. The slave port 150 of the information initiation unit 110 is coupled to the master port 140 of the information collection unit 130 through the link 111. Likewise, the slave port 150 of the information collection unit 130 is coupled to the master port 140 of the information initiation unit 110 through the link 111. There might be one or a plurality of information relay units coupled on the path where the master port 140 of the information initiation unit 110 is coupled to the slave port 150 of the information collection unit 130, and on the path where the master port 140 of the information collection unit 130 is coupled to the slave port 150 of the information initiation unit 110. Based on the coupled relation described above, a ring type topology is formed. According to an embodiment of the invention, since all the information initiation unit 110, the information relay units 120, and the information collection unit 130 includes at least one the master port 140 and at least one the slave port 150, the information initiation unit 110, the information relay units 120, and the information collection unit 130 could change roles to one another. That is, the information initiation unit 110, the information relay units 120, and the information collection unit 130 all could initiate, relay, or respond the transaction.

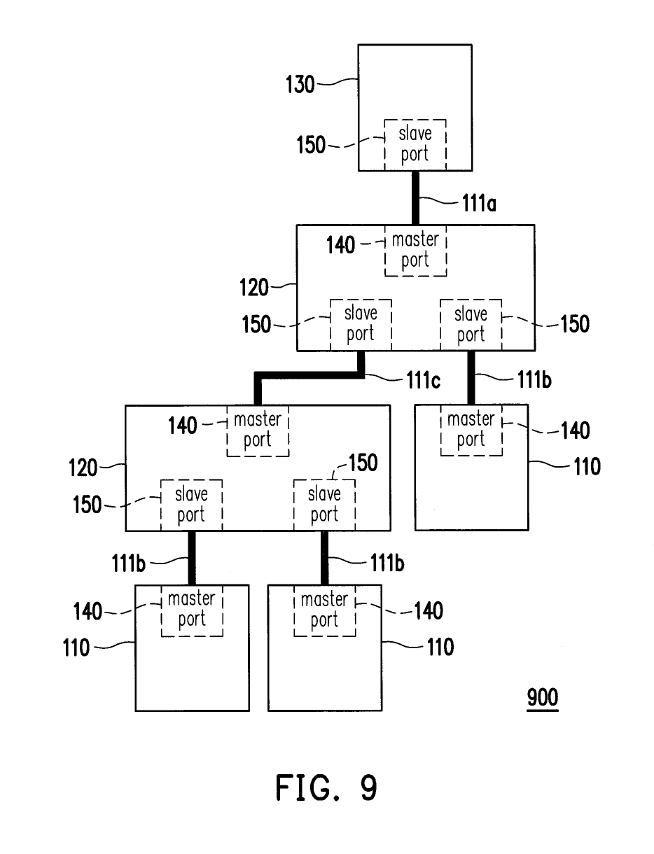

FIG. 9 shows a schematic view of an information collection system 900 according to an embodiment of the invention. Please refer to FIG. 9. The information collection system 900 includes one information collection unit 130, one or a plurality of information relay units 120, and a plurality of information initiation units 110. Compared with the embodiment of FIG. 1, the information relay units 120 further include a plurality of slave ports 150. The information collection unit 130 is coupled to one of the information relay units 120 through a link 111a. Part of the information relay units 120 may be coupled to the information initiation units 110 through links 111b. In addition, part of the information relay units 120 may be coupled to part of the information relay units 120 through a link 111c. According to the coupled relation described above, a tree type topology is formed in an information collection system 900 of the embodiment. In this kind of the embodiment, the information collection unit 130 could collect information from a plurality of the information initiation units 110.

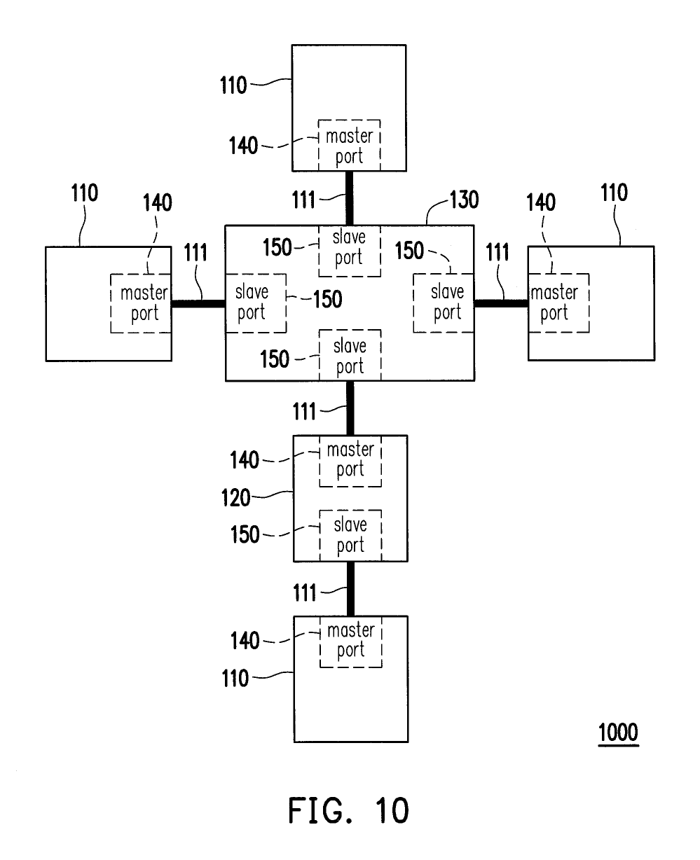

FIG. 10 shows a schematic view of an information collection system 1000 according to an embodiment of the invention. Please refer to FIG. 10. The information collection system 1000 includes an information collection unit 130, at least an information relay unit 120, and a plurality of information initiation units 110. Compared with the embodiment of FIG. 1, the information collection unit 130 further include a plurality of slave ports 150. The information collection unit 130 is coupled to the information initiation units 110 through links 111. Wherein, at least one the information relay unit 120 is coupled between one of the paths where the information initiation units 110 are respectively coupled to the slave ports 150 of the information collection unit 130. According to the coupled relation described above, a star type topology is formed in an information collection system 1000 of the embodiment. In this embodiment, a plurality of the information initiation units 110 could initiate a plurality of the transactions to the information collection unit 130 simultaneously.

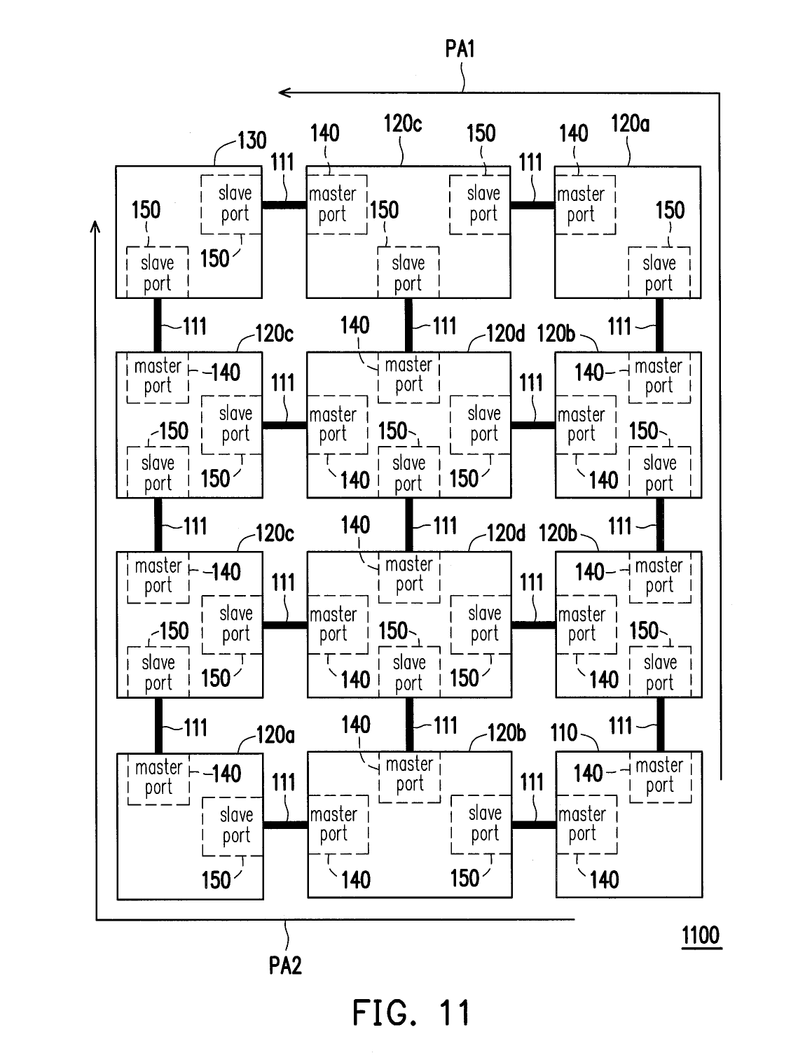

FIG. 11 shows a schematic view of an information collection system 1100 according to an embodiment of the invention. Please refer to FIG. 11. The information collection system 1100 includes at least one information initiation unit 110, one information collection unit 130, and a plurality of information relay units 120a, 120b, 120c, and 120d. Compared with the embodiment of FIG. 1, the information initiation unit 110 may further include a plurality of master ports 140, and the information collection unit 130 may further include a plurality of slave ports 150. Besides, the information relay units 120a may include at least one master port 140 and at least one slave port 150, and the information relay units 120b may include a plurality of the master ports 140, and the information relay units 120c may include a plurality of the slave ports 150, and the information relay units 120d may include a plurality of the master ports 140 and a plurality of the slave ports 150. Each of the master ports 140 of the information initiation unit 110 may be coupled to one of the information relay units 120b respectively through links 111. Each of the slave ports 150 of the information collection unit may be coupled to one of the information relay units 120c through the links 111. The master ports 140 of the information relay units 120a may be coupled to the information relay units 120c, and the slave ports of the information relay units 120a may be coupled to the information relay units 120b through the links 111. Part of the master ports 140 of the information relay units 120b may be coupled to the information relay units 120d, and part of the master ports 140 of the information relay units 120b may be coupled to the information relay units 120a or 120b through the links 111. Part of the slave ports 150 of the information relay units 120c may be coupled to the information relay units 120d, and part of the slave ports 150 of the information relay units 120c may be coupled to the information relay units 120a or 120c through the links 111. Part of the master ports 140 of the information relay units 120d may be coupled to the information relay units 120c or 120d through the links 111. In addition, part of the slave ports 150 of the information relay units 120d may be coupled to the information relay units 120b or 120d through the links 111. According to the coupled relation described above, a mesh type topology is formed.

In the embodiment of FIG. 11, the information initiation unit 110 could initiate multiple transactions to the information collection unit 130 through different paths simultaneously. For example, a transaction might be initiated to one of the slave port 150 of the information collection unit 130 through a path PA1, and the transaction is relayed through a plurality of the information relay units 120b, at least one the information relay unit 120a, and at least one the information relay unit 120c on the path PA1. At the same time, another transaction might be initiated to one of the slave port 150 of the information collection unit 130 through a path PA2, and the transaction is relayed through at least one the information relay unit 120b, at least one the information relay unit 120a, and a plurality of the information relay units 120c on the path PA2.

In summary, an information collection system is provided in the invention, and the information collection system includes one or a plurality of information initiation units for initiating a transaction, one of more information relay units for relaying the transaction, and one or more information collection units for responding the transaction. Wherein, each of the information initiation units includes at least one master port, and each of the information collection units includes at least one slave port, and each of the information relay units includes at least one the master port and at least one the slave port. Each of the master ports is coupled to each of the slave port through links wherein the links includes independent response signals which could be asserted during a data phase or an end of frame phase. Through the behaviour of the links, the transaction is efficient. Besides, various topologies are formed with the master ports and the slave ports in the information collection system. Then, the multiple applications of information collection systems are applied through the various topologies and multiple transactions may be transferred at the same time depending on the topologies.

It will be apparent to those skilled in the art that various modifications and variations can be made to the structure of the invention without departing from the scope or spirit of the invention. In view of the foregoing, it is intended that the invention covers modifications and variations of this invention provided that they fall within the scope of the following claims and their equivalents.

What is claimed is:

1. An information collection system, comprising:
an information collection unit, comprising at least one slave port, and the information collection unit responding a transaction through the slave port; and
one or more information initiation units, comprising at least one master port, and the information initiation unit initiating the transaction through the master port;
wherein the transaction comprises a write transaction, wherein during a identification phase, the master port of the information initiation unit delivers a header, and the slave port of the information collection unit accepts the transaction according to the header, and during a data phase, the master port of the information initiation unit delivers data to the slave port of the information collection unit;
wherein the transaction is initiated, relayed or responded through a link, and the link comprises:
a frame signal, asserted by the master port for declaring to occupy the link;
a data bus, information of the transaction delivered through the data bus; and
response signals, the slave port informing the master port that the transaction is accepted through the response signals with an accepted state, and wherein the transaction comprises:
an identification phase;
an end-of-frame phase, indicating the end of the transaction; and
an idle phase, indicating that the link is idle and is ready to deliver a new transaction.

2. The information collection system as claimed in claim 1, further comprising:
an information relay unit, comprising at least one master port and at least one slave port, and the information relay unit relaying the transaction through the master port and the slave port.

3. The information collection system as claimed in claim 2, wherein the information relay unit further initiates the transaction through the master port of the information relay unit.

4. The information collection system as claimed in claim 2, wherein the information relay unit further responds the transaction through the slave port of the information relay unit.

5. The information collection system as claimed in claim 1, wherein the transaction further comprises a read transaction, wherein during the identification phase, the master port of the information initiation unit delivers the header, and the slave port of the information collection unit accepts the transaction according to the header, and during the data phase, the slave port of the information collection unit delivers data to the master port of the information initiation unit.

6. The information collection system as claimed in claim 5, wherein the response signals with the accepted state are used to indicate the valid data while in the read transaction.

7. The information collection system as claimed in claim 1, wherein during an end of frame phase, the master port of the information initiation unit de-asserts the frame signal and stops delivering the information through the bus, and after confirming the state of the response signals, the master port de-asserts the validation signal.

8. The information collection system as claimed in claim 1, wherein the transaction further comprises a speculative write transaction, wherein the transaction is accepted before the data of the transaction are delivered or verified.

9. The information collection system as claimed in claim 1, wherein the transaction comprises a special transaction, and after delivering the header, the transaction enters the end of frame phase.

10. The information collection system as claimed in claim 2, wherein when the information relay unit relays a transaction, the information relay unit bypasses the frame signal, the validation signal, and the information of the transaction from the link coupled to the slave port of the information relay unit to the link coupled to the master port of the information relay unit, and the information relay unit bypasses the response signals from the link coupled to the master port of the information relay unit to the slave port of the information relay unit.

11. The information collection system as claimed in claim 1, wherein the header comprises identification information, a transaction priority, a data length, and verification information.

12. The information collection system as claimed in claim 11, wherein the identification information comprises a source and a destination of the transaction and the information relay unit relays the transaction according to the identification information, and the information relay unit responds the transaction according to the identification information.

13. The information collection system as claimed in claim 11, wherein the information relay unit yields the transaction according to the transaction priority in a race condition, wherein the race condition occurs when the two transactions require the information relay unit for relaying to the same slave port at the same time.

14. The information collection system as claimed in claim 11, wherein the slave port of the information collection unit aborts the transaction when the information collection unit can not accept the transaction.

15. The information collection system as claimed in claim 11, wherein the verification information includes a code of cyclic redundancy check for verifying the accuracy of the header.

16. The information collection system as claimed in claim 11, wherein the header comprises a transaction type for indication if the transaction is a read transaction or a write transaction.

17. The information collection system as claimed in claim 1, wherein the transaction further comprises a digest, and the digest comprises a cyclic redundancy check for verifying the accuracy of the data of the transaction.

18. The information collection system as claimed in claim 1, wherein the response signals further comprise an aborting state to indicate that the transaction is aborted.

19. The information collection system as claimed in claim 1, wherein the response signals further comprise a yielding state to indicate that the transaction is yielded.

20. The information collection system as claimed in claim 1, wherein the transaction further comprises:
a data phase, indicating the link is delivering the data.
